(19) United States
(12) Patent Application Publication
(10) Pub. No.: US 2014/0284284 A1
(43) Pub. Date: Sep. 25, 2014

(54) Apparatus to dispense immiscible liquid from an inverted bottle

(71) Applicant: John R. Troost, Akron, OH (US)

(72) Inventor: John R. Troost, Akron, OH (US)

(73) Assignee: John R. Troost, Akron, OH (US)

(21) Appl. No.: 13/847,451

(22) Filed: Mar. 19, 2013

(51) Int. Cl. B01D 17/02

(52) U.S. Cl. CPC B01D 17/0214
USPC 210/800; 210/95

(57) ABSTRACT

A device, an improvement upon a funnel, to enable immiscible liquids to be dispensed from an inverted bottle to augment a new, in-situ method to extract chemicals from water directly within sampling containers.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

This invention relates in general to a method and apparatus for extracting organic chemicals from water directly within sample collection vessels, More specifically, the invention relates to an apparatus and procedure designed to effect the removal of an immiscible solvent from an inverted bottle following an in-situ liquid-liquid extraction process.

Water is routinely sampled and tested for chemical contaminants for human health and a number of other reasons. Most chemical analysis methods require removal of organic chemicals from water by partitioning into an immiscible solvent, often heavier than water, by a process known as liquid-liquid extraction. If the chemicals to be extracted have a greater affinity for the solvent than the water, and, if there is sufficient interaction between the extracting solvent and the water, the contaminating chemicals transport from the water to the solvent and the process will be effective. There are two techniques commonly in use today.

The most common features use of a separatory funnel, generally a pear shaped vessel fashioned with a cap on one end and a narrow opening with a stop-cock on the other. A water sample and an extracting solvent are added together and vigorously shaken either manually or mechanically for a period of time to maximize interaction between the water and solvent. Subsequently, the separatory funnel is stood upright and the liquid layers are allowed to settle and separate until a clear demarcation between the liquid layers may be observed. Removing the cap for ventilation and by manipulating the stopcock, the lower layer is manually drained off into another container by observing the movement of the visible interface (meniscus) between the two fluids. The housing of the separatory funnel, or at least a portion of it, must necessarily be clear or at least translucent to facilitate viewing a moving interface. The procedure is often repeated with fresh solvent to maximize the recovery of the extraction process. Thus, a separatory funnel has a dual purpose, to provide a mixing chamber for water and an extracting solvent as well to serve as a vehicle for separating the two liquids following the extraction. An example of a separatory funnel may be found in U.S. Pat. No. 1,049,411 issued to Roscoe H. Shaw on Jan. 7, 1913.

U.S. Pat. No. 5,478,478 issued to Sandra Griswold on Dec. 26, 1995 introduced a modification to facilitate the separation of two fluids within a separatory funnel by preventing vortexing. U.S. Pat. No. 5,580,528 issued to James P. Demers on Dec. 3, 1996 introduces an unbreakable plastic stem to a glass separatory funnel improving the safety and durability of the device.

Another technique commonly used to extract water samples, continuous liquid-liquid extraction, makes use of an elaborate glass apparatus to automate the process. A heavier than water, substantially immiscible solvent (typically methylene chloride) is boiled and vaporized up into a cold water jacket. Re-liquidified solvent drops into a vessel containing the water sample and the solvent is recycled. The initial process generally takes 18 to 24 hours and is most often followed by a second extraction of 18 to 24 hours after altering the pH of the water sample. U.S. Pat. No. 5,156,812 is an example of this apparatus.

With a fairly new technique, organic compounds may also be removed from water by passing the water through a solid sorbent material from which the pollutants may subsequently be dislodged with solvent or a mixture of solvents.

With these procedures the separated solvent, now containing the chemicals that had originally been in the water, is usually reduced in volume (concentrated) by evaporation to enable the extracted organic compounds to be detected at extra low levels. All of these processes are labor intensive, costly, time-consuming and subject to contamination from a number of sources.

This invention was born of a need to remove extracting solvent from a bottle, an obstacle posed by the development a new, greatly simplified method for extracting chemicals from water. With this new technique, solvent (or a mixture of solvents) is added directly to the water in original sample vessels to enable the extraction to take place directly within the bottles used to collect, transport and store the water samples (an in-situ extraction). Once the solvent(s) is introduced, the bottles are spun horizontally for a number of hours at 3 rpm. This subtle movement provides the necessary interaction between the water and solvent to obtain an extraction result equaling or exceeding the efficiency of those processes in use today as described above. This new method for extracting chemical from water, of which this patent device is an essential element, has important advantages. Among these are significant solvent usage reduction (a green technology), labor abatement, improved precision, contamination minimization, enhanced safety, and greatly reduced cost.

The initial research conducted to explore and refine the new extraction method was necessarily, counterproductively, administered using a piece of equipment the technique was, in part, designed to replace. A separatory funnel (as mentioned above) was the only tool available to effect the removal of the extracting fluid from the bottles following the in-situ process. A clear and obvious need to find a simpler means to dispense the extracting solvent from an inverted bottle led to the discovery and refinement of the subject device (given the name “funnel-cock”).

The device is a modification of a funnel. There is prior art regarding the improvement of funnels. In 1866, two patents were issued, one to Arthur Wilson (No. 53,074) to allow a funnel to be attached to a faucet to control flow. The second patent was issued to A. H. Whitney (No 55,941) entailing an improvement to a funnel to allow liquids to be measured and dispensed in a simplified manner. U.S. Pat. No. 105,857, issued to Franklyn Smith Jul. 26, 1870, describes an improvement to a measuring funnel to enable flammable liquids to be dispensed safely by eliminating exposure to air.

### BRIEF SUMMARY OF THE INVENTION

The invention prototype is a funnel adaptation created to enable immiscible solvent to be dispensed from an inverted bottle in a controlled, efficient manner. The device need be fabricated of a clear or translucent material, etched with grooves or forged with ridges on the inner surface and fitted with a stopcock. The large opening of the funnel is sized specifically to comfortably seat and mate with the lip of inverted bottles of varying sizes and shapes, particularly those commonly used for water sampling. The dimensions are further refined to create a gap to retain the inevitable but limited spillage that occurs when a bottle full of liquid(s), is inverted onto the device. The grooves or ridges are strategically placed to prevent a seal from forming between the inverted bottle lid and the inner funnel surface. Consequently, when the funnel is used to discharge a heavier than water solvent from an inverted bottle, the grooves or ridges allow air to enter the bottle while the fluid is being dispensed thereby striking a balance between a vacuum formed within the bottle headspace and atmospheric pressure. The clear or translucent construction material allows the fluid discharge to be viewed while the flow is controlled with a stopcock.

More specifically, the invention entails a funnel of specific conical size and shape made of clear or translucent material, or containing at least a section of clear or translucent material, with a larger circular open top end and a smaller tubular lower end. The smaller tubular end may house or be fashioned to house a stopcock or other flow controlling mechanism. The inner surface of the upper part of the funnel is etched with one or more grooves or is fabricated with one or more ridges. As the bottle full of liquid and funnel are clasped and inverted together, the purposeful extension of the funnel beyond the lid of the bottle is made to create a void sufficient to retain overflow limited and controlled by the natural competing forces of vacuum and pressure. Moreover, the sizing allows for a snug fit (but not seal) about the neck of the bottle while the funnel wall is extended up over the neck up to but not quite reaching the base of the bottle, typically 1 liter in size. Thus an overflow containment space is formed within the flat funnel wall, the cylindrical bottle neck and the lip of the bottle. The groove(s) or ridges(s) within the funnel prevent a seal about the lid of the bottle and allow venting to occur in a controlled fashion as the stopcock is opened and the fluid is discharged.

It should be appreciated by those skilled in the art that the conception and the specific embodiments disclosed may be readily utilized as a basis for modifying or designing other structures for carrying out the same purpose of the present invention. It should also be realized by those skilled in the art that such equivalent constructions do not depart from the spirit and scope of the invention as set forth in the claim of the invention.

### BRIEF DESCRIPTION OF THE SEVERAL VIEWS OF THE DRAWING(S)

For a more complete understanding of this invention and the advantages thereof, reference is made to the following descriptions taken in conjunction with the accompanying drawings in which:

FIG. 1. is a diagrammatic view of one embodiment of the “funnel cock” depicting the general funnel shape, stopcock attachment and inner grooves; and

FIG. 2. is a diagrammatic view of an embodiment fitted to a narrow mouth bottle containing two liquid phases inverted onto a funnel cock illustrating the utility of the invention.

FIG. 3. is a diagrammatic view of another embodiment fitted to a wider mouth bottle containing immiscible liquids overturned on a funnel cock further depicting the function of the device.

### DETAILED DESCRIPTION OF THE INVENTION

Embodiments of the funnel cock are given in the accompanying drawings.

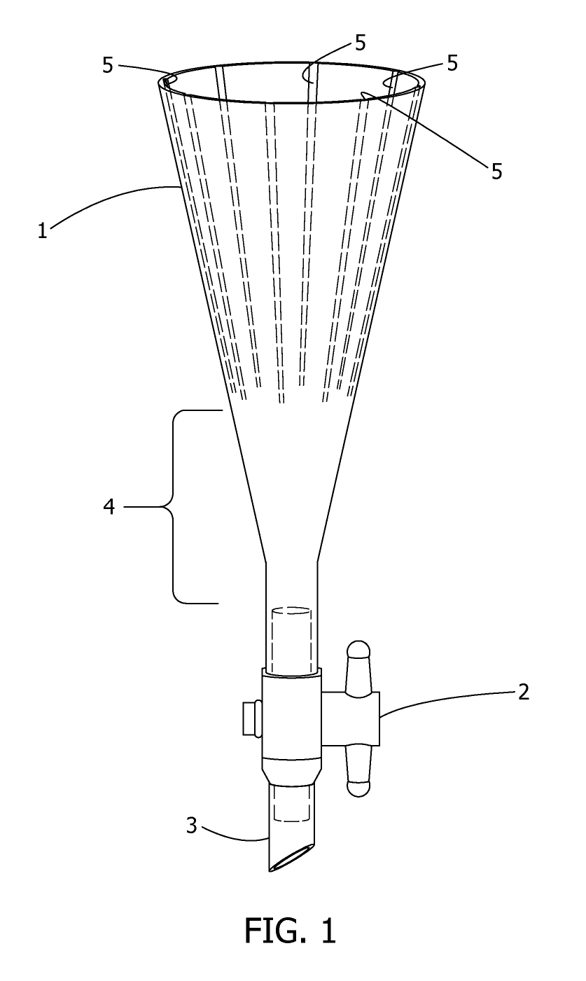

As shown in FIG. 1, the funnel cock 1 is fabricated to house a stopcock 2, a spout 3 and grooves or ridges 5. To promote the intended purpose of the funnel cock, the body is molded of a translucent material (fluorinated ethylene propylene) to enable viewing 4 an interface between liquid layers passing through the device. All construction materials including the stopcock (polypropylene) are necessarily inert to prevent damage from chemically aggressive solvents often used to extract organic chemicals from water.

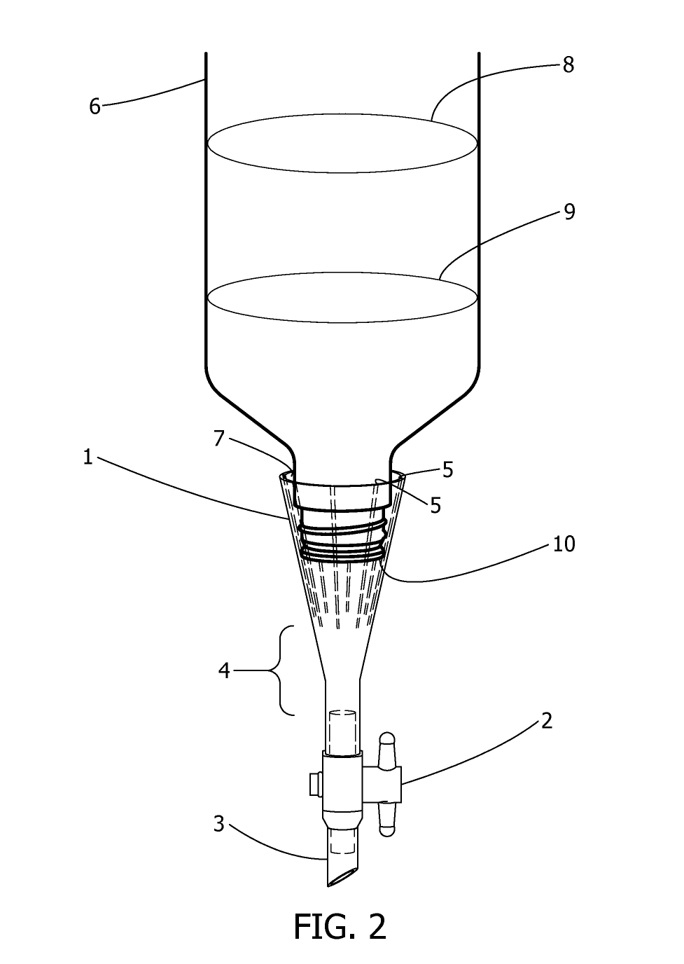

FIG. 2 provides a diagrammatic view of the utility of the funnel cock. A narrow mouth (“Boston round”) inverted bottle 6 containing two phases of liquid, a top layer 8 and a bottom layer 9 is reposed onto an upright funnel cock 1. To accomplish this, typically the funnel cock is first placed upside down on an uncapped, upright bottle containing the liquid phases. The funnel cock and bottle are clasped together as they are inverted. With this act of inversion, a limited amount of liquid escapes but is contained, by design, by the inner open space 7 between the funnel cock wall, the lip of the bottle 10 and the main body of the bottle. As the stopcock 2 is opened and the heavy liquid phase 9 is permitted to traverse through the funnel cock, the moving meniscus (interface) between the layers is able to be viewed 4 through the translucent wall of the funnel. The bottom liquid layer may therefore be quantitatively discharged and separated from the top layer by closing the stopcock just as the interface between the layers passes into the stopcock.

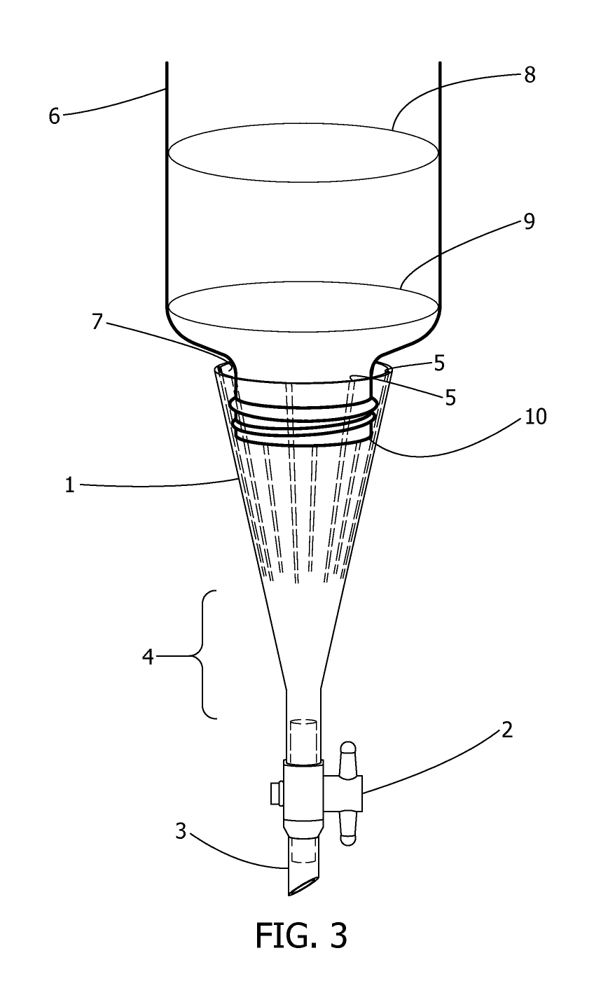

FIG. 3 offers a diagrammatic view of the device customized to fit another common bottle 6 with a wider mouth. The diameter of the large open end of the funnel cock 1 is made larger to snugly cradle the inverted wider mouth bottle about the lip 10 while grooves or ridges 5 prevent the surfaces from forming a seal. Since the neck of this bottle type is short, it is also critical with this configuration that the large open end of the funnel extend entirely up to the body of the bottle to create a gap 7 of sufficient volume to contain overflow.

1. I claim a funnel adaptation to facilitate the separation of an immiscible liquid contained in an inverted bottle, comprising:
a conical chamber having a longitudinal axis a large inlet opening and a smaller outlet opening for allowing liquid to pass through the chamber; and
of specific size and shape for the inner diameter of the large inlet opening to exactly match the outer diameter of the lip of a bottle at a point not less than 1 centimeter below the crest of the large inlet opening, the 1 centimeter or more said extension of the wall of the funnel, when upon the bottle with the mated lip diameter is inverted and inserted onto the open large inlet of funnel, forms another chamber in the region between the lip of the bottle, the neck of the bottle and the inner wall of the funnel that is utilized to retain liquid overflow; and
fabricated with one or more substantially vertical grooves or ridges on the upper inner wall traversing the point at which the diameters of the funnel and lip of the mated bottle are identical that prevent a seal from forming while allowing air to enter the bottle when fluids within the mated bottle inverted onto the funnel are discharged; and
constructed of a clear or translucent material, or containing a section of clear or translucent material in the wall of the funnel between the smaller outlet opening and the larger inlet opening whereby the interface between two immiscible liquids may be visualized as the fluids flow through the body of the funnel; and
having a smaller lower end equipped or fitted to equip a stopcock, valve or other liquid flow controlling device.

2. I claim the apparatus of claim 1 wherein the material of construction of the funnel body is fluorinated ethylene propylene, glass or other clear or translucent material necessarily inert to prevent damage from chemically aggressive solvents commonly used to extract organic chemicals from water.

3. I claim the apparatus of claim 1 wherein the valve or stopcock is fabricated of polypropylene or other inert material.

4. I claim the apparatus of claim 1 terminating at the smaller outlet opening with a section of thin wall tubing that may be manually or mechanically clasped to control liquid flow passing through it.

5. I claim the apparatus of claim 1 terminating at the smaller outlet opening with a filter, or receptacle to attach a filter, fabricated of an inert, hydrophobic mmbrane allowing organic solvents to pass while obstructing the passage of water.

6. I claim the apparatus of claim 1 wherein the seal preventing protrusions or indentations on the upper inner wall traversing the point at which the diameters of the funnel and lip of the mated bottle are identical are of any size or orientation.

7. I claim a method for separating at least two immiscible liquids, to include the steps of:
(a) inverting a bottle containing immiscible liquids onto a funnel equipped with a flow regulating device;
(b) allowing the heavier immiscible liquid to pass through the funnel as the interface between the fluids is viewed though a clear or translucent wall of the funnel;
(c) preventing a seal from forming while allowing air to enter the bottle when fluids within the bottle inverted onto the funnel are discharged
(d) containing overflow that naturally occurs with the act of overturning a bottle full of liquids onto an open funnel.
